(19) United States
(12) Patent Application Publication
(10) Pub. No.: US 2007/0111578 A1
(43) Pub. Date: May 17, 2007

(54) Socket adapter mold

(76) Inventors: Alfred J. Langon, Cranston, RI (US); Richard J. Alviti, Cranston, RI (US)

Correspondence Address: FISH & RICHARDSON PC, P.O. BOX 1022, MINNEAPOLIS, MN, 55440-1022, US

(21) Appl. No.: 11/273,763

(22) Filed: Nov. 15, 2005

(51) Int. Cl. H01R 13/62

(52) U.S. Cl. 439/300

(57) ABSTRACT

A method of manufacturing a mold and a mold for forming an intercoupling component of the type used to couple an array of electrical connection regions disposed on a first substrate to an array of electrical connection regions disposed on a second substrate. A plurality of plates are provided, each plate including an array of holes arranged in a pattern corresponding to the array of electrical connection regions of the first substrate. A base is formed by stacking the plates with the holes substantially aligned. Pins are inserted into apertures formed in the base by the aligned holes. A housing is assembled with the base, pins, at least one sidewall, and a cover, the housing including a substantially enclosed cavity, the housing also including at least one opening to enable injection of molten material into the cavity.

### TECHNICAL FIELD

This invention relates to intercoupling components of the type used to couple an array of electrical connection regions disposed on a first substrate to an array of electrical connection regions disposed on a second substrate, and more particularly to a mold and method for manufacturing a mold for forming such intercoupling components.

### BACKGROUND

Intercoupling components of the type used to couple an array of electrical connection regions disposed on a first substrate to an array of electrical connection regions disposed on a second substrate can be formed of an insulative member with apertures in which electrical terminals such as pins and sockets are inserted. Such insulative members can be molded of thermoplastics in electric or hydraulic mold presses. Mold inserts associated with this process can be formed by machining metal blocks to receive pins at locations corresponding to the desired locations of the apertures.

### SUMMARY

One aspect of the invention features a method of manufacturing a mold for forming an intercoupling component of the type used to couple an array of electrical connection regions disposed on a first substrate to an array of electrical connection regions disposed on a second substrate. The method includes providing a plurality of plates, each plate including an array of holes arranged in a pattern corresponding to the array of electrical connection regions of the first substrate; forming a base by stacking the plates with the holes substantially aligned; inserting pins into apertures formed in the base by the aligned holes; and assembling a housing with the base, pins, at least one sidewall, and a cover, the housing including a substantially enclosed cavity, the housing also including at least one opening to enable injection of molten material into the cavity.

Another aspect of the invention features a mold for forming an intercoupling component of the type used to couple an array of electrical connection regions disposed on a first substrate to an array of electrical connection regions disposed on a second substrate. The mold includes a base, at least one sidewall, and a cover, which together define a substantially enclosed cavity, at least one of the base, at least one sidewall, and cover including at least one opening to enable injection of molten material into the cavity; and pins extending from the base into the mold cavity, the pins having first ends received by the base and second ends contacting an interior surface of the cover. The base includes a plurality of plates, each plate having an array of holes arranged in a pattern corresponding to the array of electrical connection regions of the first substrate.

In some embodiments, each plate has a first thickness between about 0.010 inch (0.254 millimeter) and 0.014 inch (0.356 millimeters). In some instances, the base has a second thickness between about 0.20 inch (5.1 millimeters) and 0.70 inch (18 millimeters). Each plate can include stainless steel.

In some embodiments, forming the base comprises stacking between about 10 and 100 plates (e.g., between about 20 and 50 plates). The plurality of plates can be stacked with the arrays of holes substantially aligned. The aligned arrays of holes can form arrays of apertures receiving the pins. Each of the holes can have a diameter of between about 0.009 inch (0.229 millimeter) and 0.012 inch (0.305 millimeter). The array of holes can include a first sub-array of holes and a second sub-array of holes. In some instances, each of the first sub-array of holes has a first diameter and each of the second sub-array of holes has a second diameter that is less than the first diameter. In some instances, a first subset of core pins is received by the first sub-array of holes and a second subset of core pins is received by the second sub-array of holes, the first subset of core pins having first diameter in the mold cavity that is greater than a second diameter of the second subset of core pins in the mold cavity.

In some embodiments, providing the plates can include machining the plates to form the array of holes with a pitch of between about 0.012 inch (0.3 millimeter) and 0.031 inch (0.8 millimeter). Providing the plates can feature forming the array of holes by laser machining each plate. Providing the plates can also feature forming the array of holes with diameters between about 0.009 inch (0.229 millimeter) and 0.012 inch (0.305 millimeter).

In some embodiments, assembling the base and pins with the at least one sidewall, and cover includes contacting an interior surface of the cover with distal ends of the pins.

In some embodiments, each core pin includes a distal end contacting the interior surface of the cover, the distal end having a substantially planar surface such that contact between the distal end and the interior surface of the cover inhibits the flow of molten material between the distal end and the interior surface.

Manufacturing a mold as provided for by the various aspects of the invention can provide several advantages. In general, such methods can be used to efficiently produce molds of the type used for forming an intercoupling component of the type used to couple an array of electrical connection regions disposed on a first substrate to an array of electrical connection regions disposed on a second substrate (e.g., a socket adapter mold). More particularly, such methods can produce molds with a small (e.g., below 0.8 millimeters or about 0.5 millimeters) between adjacent core pins which are located with a high degree of precision. Providing such molds can enable the production of intercoupling components such as socket adapters with increased terminal density and reduced overall size.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a body of a socket adapter.

FIG. 2 is a side view, partially cutaway, of a mold for producing the socket adapter body shown in FIG. 1.

FIGS. 3A and 3B are, respectively, an exploded side view and perspective view of a portion of the mold shown in FIG. 2.

FIGS. 4 and 5 are plan views of core pins retaining plates of the mold shown in FIG. 2.

FIGS. 6 and 7 are side views of core pins of the mold shown in FIG. 2.

FIG. 8 is a flow chart of a method of forming the mold shown in FIG. 2.

Like reference symbols in the various drawings indicate like elements. Terms such as top and bottom are used for clarity of description to note the relative location of elements on the figures rather than to imply absolute relationships between such elements.

### DETAILED DESCRIPTION

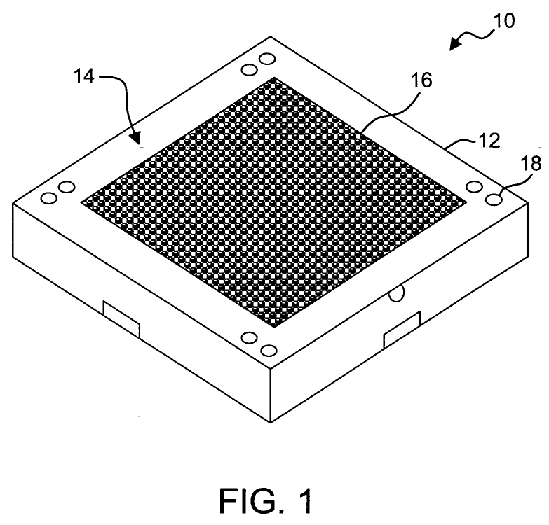

Referring to FIG. 1, a body 10 of a socket adapter is molded of thermoplastic resin (e.g., FR-4). Body 10 includes a peripheral region 12 and a central region 14. Peripheral region 12 is substantially solid and provides structural support to central region 14 which contains multiple apertures 16 that extend through body 10. Apertures 16 are sized and configured to receive terminal elements (not shown) of the socket adapter. Such terminal elements are adapted to provide electrical and mechanical connections between electrical components such as, for example, printed circuit boards, pin grid array (PGA) circuit packages, and ball grid array (BGA) circuit packages. For example, embodiments of such terminal elements are described in detail in U.S. Pat. No. 6,313,530, the contents of which are incorporated herein by reference in their entirety. In the illustrative embodiment, peripheral regions 12 of body 10 also include knockout holes 18 that are artifacts of the molding process used to make the socket adapter body.

As electrical components increase in complexity, the desired density of such terminal elements on socket adapters also increases. The corresponding increased desired density of apertures 16 in such socket adapters requires a decrease in the pitch or spacing between adjacent apertures 16. To date, the minimum pitch achievable has been limited by factors including the machining techniques used to produce the molds used to form bodies 10. An innovative mold production technique, as described in detail below, can be used to produce bodies 10 of socket adapters with apertures 16 set at a pitch of less than about 0.8 millimeters (e.g., 0.5 millimeters). This mold production technique can also be used to efficiently produce larger pitch molds.

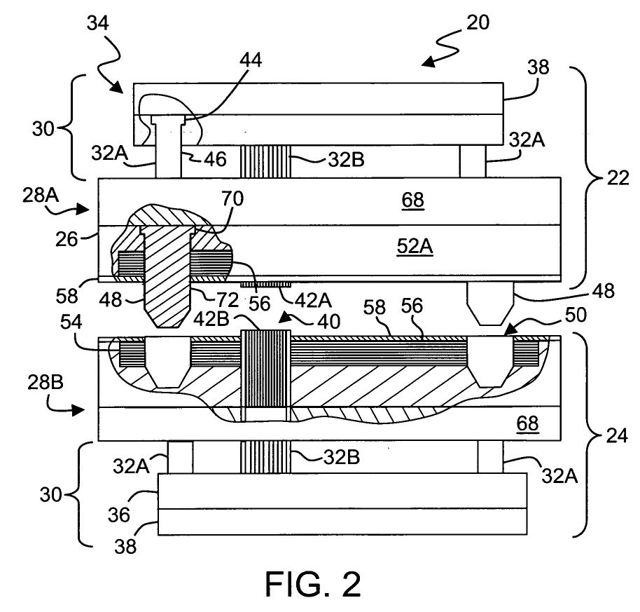

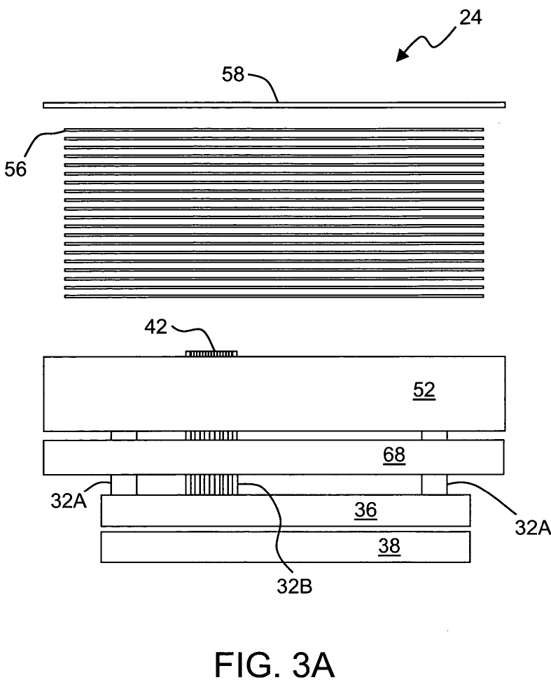

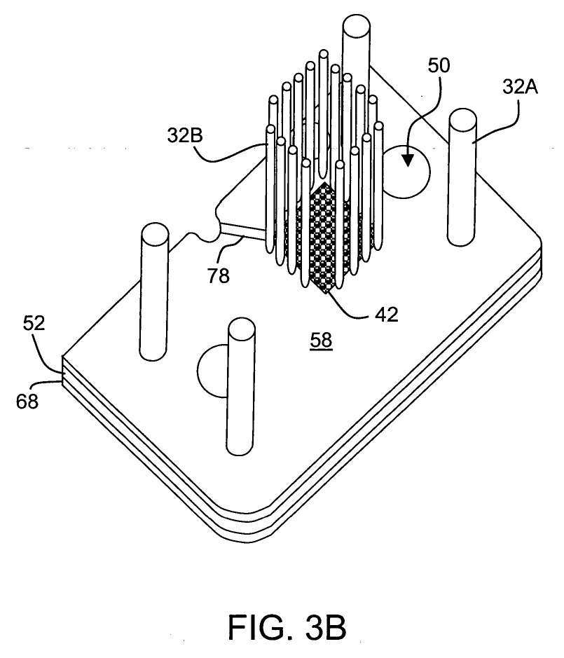

Referring to FIGS. 2, 3A, and 3B, an illustrative mold 20 includes an A-side 22 and a B-side 24 whose components are configured for interlocking engagement. A-side 22 and B-side 24 each include a main mold body 28A, 28B and a knockout system 30. Outer surfaces 26 of mold 20 are sized to standard specified dimensions for a specific electric or hydraulic mold press. As discussed above, various embodiments of mold 20 are used to produce bodies 10 for various socket adapters. Using standard specified outer dimensions facilitates switching out embodiments of mold 20 installed in a hydraulic mold press because the main mold bodies 28A, 28B are sized and configured to act as quick change cavity inserts.

Main mold bodies 28A, 28B are essentially mirror images of each other. The primary difference is that main mold body 28A of A-side 22 includes locating pins 48 while main mold body 28B of B-side 24 includes cavities 50 sized and located to receive the locating pins. Main mold bodies 28A, 28B each include a mold plate 52, a mold cavity retainer 58, and a backing plate 68. Mold plate 52 defines a plate cavity 54 which is sized and located to receive core pin retaining plates 56. A mold cavity retainer 58 is attached to mold plate 52 with screws (not shown). Mold cavity retainer 58 holds core pin retaining plates 56 in plate cavity 54 and defines a mold cavity 40.

Screws are used to attach the various pieces of the illustrative embodiment to each other and are also used to attach mold 20 to a hydraulic mold press. However, for clarity of illustration, the screws and bores which receive them are not shown.

Core pin retaining plates 56 are stainless steel plates with pin holes 60 through which core pins 42 are inserted with their ends extending into and through mold cavity 40. In other embodiments, core pin retaining plates 56 can be manufactured from other materials including, for example, tool-hardened steel. Core pins 42 are located in an array (e.g., a 25×25 array) with interstitial spaces separating adjacent core pins. Mold cavities 40 are individually open on their interior sides, but when A-side 22 and B-side 24 are assembled and placed together, the open interior sides of the two mold cavities face each other such that the two mold cavities in effect define a single cavity that is substantially enclosed with the exception of a runner 78 (FIG. 3B) that provides an aperture through which moldable material is injected into the mold cavity. When A-side 22 and B-side 24 are assembled, core pins 42 of each side fit into the interstitial spaces separating adjacent core pins of the other side and contact the top core pin retaining plate 56 of the other side. Thus, combined mold cavities 40 contain core pins 42 at locations corresponding to the desired locations of apertures 16 of socket adapter body 10. The minimum pitch of apertures 16 of socket adapter body 10 is governed in part by the degree of accuracy that can be achieved in placing and machining pin holes 60 in core pin retaining plates 56.

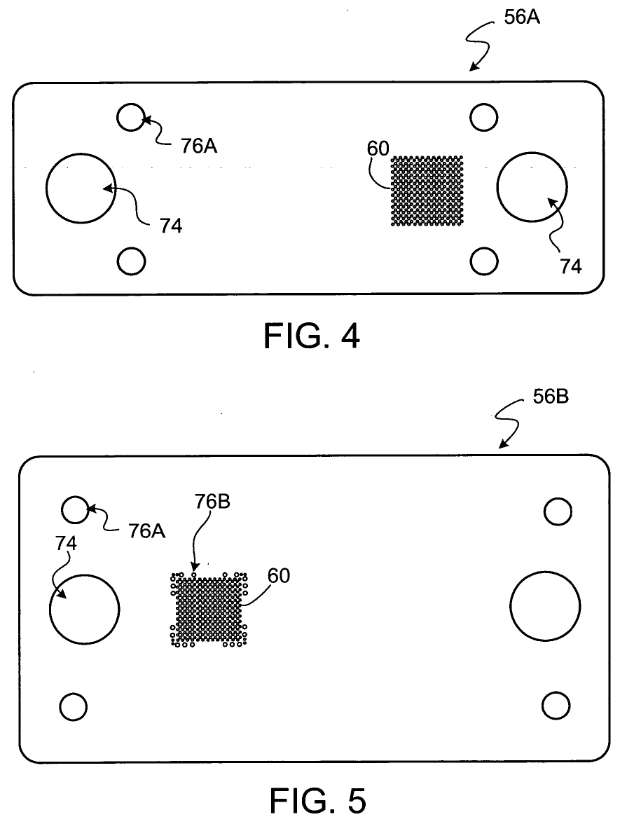

Referring to FIGS. 4 and 5, core pin retaining plates 56A of A-side 22 are thin stainless steel plates with core pin holes 60, locating pin holes 74, and knockout pin holes 76A. Core pin retaining plates 56B of B-side 24 are similar thin stainless steel plates but also include knockout pin holes 76B for receiving smaller knockout pins 32B. These stainless steel plates are approximately 0.012 inch in thickness, which allows efficient and precise machining of these holes, particularly core pin holes 60, using laser machining processes. For example, a plate can be designed with a particular arrangement of core pin holes 60 to provide a socket adapter body with a corresponding arrangement of apertures using computer-aided design software. The design can be exported from the computer-aided design software and used as data by a computer-controlled laser machining tool (e.g., a CNC machining tool). Using this approach, core pin holes 60 with a pitch of less than about 0.8 millimeters (e.g., 0.5 millimeters) can be machined with positional and machining tolerances of less than about 0.0005 inch. This is more precise than can be achieved using drilling techniques required to machine holes in thicker pieces of stainless steel.

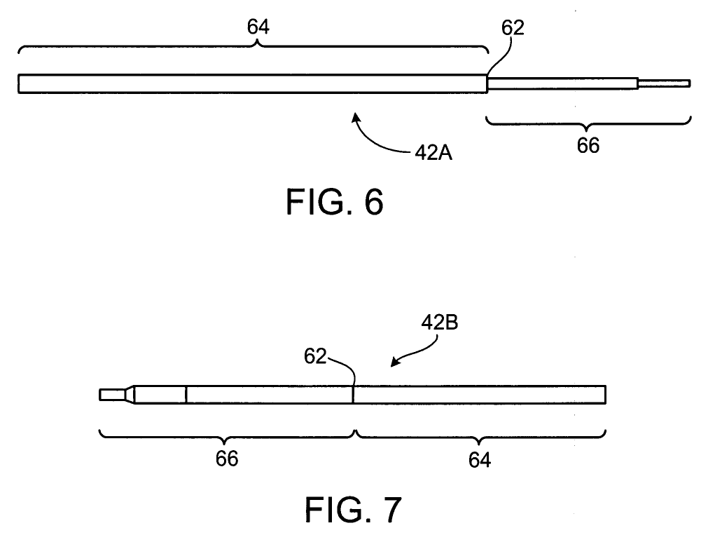

Referring to FIGS. 6 and 7, although core pins 42A for A-side 22 and core pins 42B for B-side 24 have slightly different configurations, both configurations include a shoulder 62 between a relatively thicker base end 64 and a relatively thinner pin end 66. The dimensions of base ends 64 and pin ends 66 of core pins 42 are chosen such that the pin ends fit through pinholes 60 while the base ends do not. This is important in the assembly of mold 20 as described below.

Referring again to FIG. 2, assembly of mold 20 is described. Each of the cutaway portions in FIG. 2 show a cross-sectional view of the interior of an element of mold 20 taken along the centerline of the particular element. As can be seen in the cutaway portion of mold plate 52A of A-side 22, locating pins 48 have heads 70 at the ends of stems 72. Mold plate 52A includes apertures extending through the mold plate which receive locating pins 48. Locating pins 48 are placed in these apertures with their heads 70 and a portion of their bodies 72 received within the apertures and a portion of their bodies extending outward from mold plate 52A. After locating pins 48 are placed in these apertures, backing plate 68 is attached to mold plate 52A, thus locking the locating pins into place.

After locating pins 48 are installed in main mold body 28A, the main mold body is placed with the locating pins and cavity 54 in mold plate 52 facing upwards. Core pin retaining plates 56 are then stacked in cavity 54 in mold plate 52 with locating pins 48 inserted through locating pin holes 74 in each core pin retaining plate. By providing two fixed reference points, locating pins 48 provide an efficient means of aligning core pin holes 60 in the stack of core pin retaining plates 56. After core pin retaining plates 56 are placed in cavity 54, mold cavity retainer 58 is attached to mold plate 52A. Main mold body 28A is placed so that backing plate 68 now faces upwards. Backing plate 68 is removed, thus exposing aligned core pin holes 60 for manual insertion of core pins 42A into core pin retaining plates 56. After core pins 42A are inserted, backing plate 68 is attached to mold plate 52A thus locking locating pins 48 and core pins 42A into place.

As described above, core pin holes 60 can be machined in core pin retaining plates 56 with a high degree of precision partly because the plates are thin. This precise location of core pin holes 60 is complemented by the alignment of the core pin holes on stacked core pin retaining plates 56 provided by locating pins 48. The stacks of core pin retaining plates 56 can thus hold core pins 42A, 42B in place with a similar degree of rigidity as a solid block.

Main mold body 28A is then placed with mold cavity retainer 58 and extended locating pins 48 facing upwards. Mold cavity retainer 58 of B-side 24 is placed on top of A-side 22 with locating pins 48 extending through the B-side mold cavity retainer. Core pin retaining plates 56 and mold plate 52B of B-side 24 are then placed on top of mold cavity retainer 58. After mold cavity retainer 58 is attached to mold plate 52B, core pins 42B are manually installed and backing plate 68 is attached to mold plate 52B. As can be seen on the cutaway portion of main mold body 28B, shoulders 62 of core pins 42B engage the bottommost core pin retaining plate 56. Thus, when backing plate 68 is attached to mold plate 52, the backing plate holds core pins 42B in place.

Knockout pins 32A, 32B of knockout systems 30 extend from a two-piece block 34. Four larger knockout pins 32A are generally located towards the comers of two-piece plot 34. As can be seen in the cutaway portion of the upper two-piece block 34, larger knockout pins 32A include a head 44 at the end of the stem 46. The outer dimensions of heads 44 are larger than the outer dimensions of stems 46. For example, in the illustrative system, heads 44 and stems 46 of larger knockout pins 32A have diameters of about 0.066 inch and 0.046 inch, respectively. In this embodiment, seventeen smaller knockout pins 32B are located around the perimeter of a mold cavity 40 into which core pins 42 extend and have similar heads and stems.

Each two-piece block 34 has an interior portion 36 and an exterior portion 38 attached to each other with the interior portion located on the side of the two-piece block facing towards an adjacent main mold body 28A, 28B. Interior portion 36 includes apertures extending through the interior portion but are sized and located to receive knockout pins 32A, 32B. Knockout pins 32A, 32B are placed in the apertures with their heads 44 and a portion of their bodies 46 received within the apertures a part of their bodies extend outward from the apertures. End surfaces of heads 44 are aligned with adjacent surfaces of interior portion 36. After knockout pins 32A, 32B are placed in the apertures, exterior portion 38 is attached to interior portion 36, thus locking the knockout pins into place. Although the illustrative embodiment of the knockout system is easily manufactured and assembled, other approaches to providing a similar mechanism can also be used.

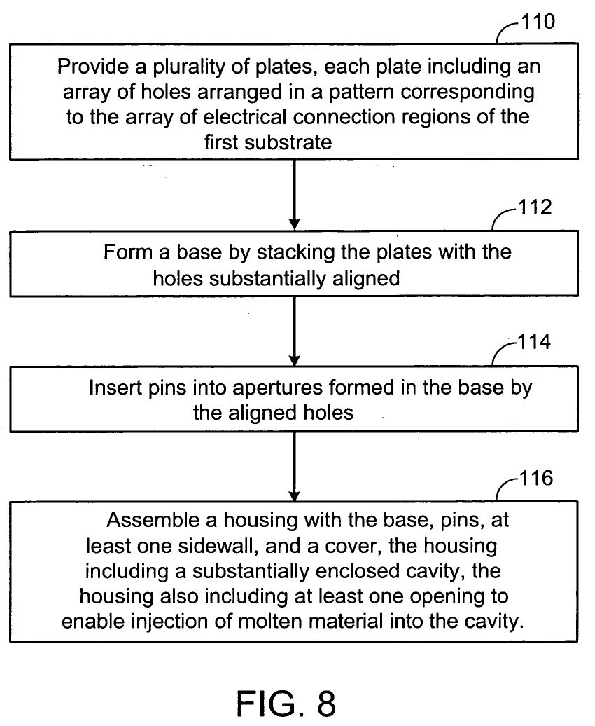

Referring to FIG. 8, assembly of the mold thus includes providing a plurality of plates, each plate including an array of holes arranged in a pattern corresponding to the array of electrical connection regions of a first substrate (step 110). A base is formed by stacking the plates with the holes substantially aligned (step 112). Pins are inserted into apertures formed in the base by the aligned holes (step 114). Finally a housing is assembled with the base, pins, at least one sidewall, and a cover, the housing including a substantially enclosed cavity, the housing also including at least one opening to enable injection of molten material into the cavity (step 114).

Each plate can have a first thickness between about 0.010 inch (0.254 millimeter) and 0.014 inch (0.356 millimeters). The plates can be made of stainless steel. Providing the plates can include forming the array of holes by laser machining each plate, particularly, machining the plates to form the array of holes with a pitch of between about 0.012 inch (0.3 millimeter) and 0.031 inch (0.8 millimeter), more particularly, with diameters between about 0.009 inch (0.229 millimeter) and 0.012 inch (0.305 millimeter).

The base can have a second thickness between about 0.20 inch (5.1 millimeters) and 0.70 inch (18 millimeters). Forming the base can include stacking between about 10 and 100 plates, more particularly stacking between about 20 and 50 plates.

Assembling the base and pins with the at least one sidewall, and cover can include contacting an interior surface of the cover with distal ends of the pins.

In one example, an alternate embodiment of a mold was assembled substantially as described above with the exception that only the B-side had an associated knockout system. The mold was sized and configured for use with a Nissei Electric NEX 500 mold press and the main mold bodies had exterior dimensions of approximately 3.5 inch×5 inch×2.6 inch. In a given operational cycle, the mold press injects molten Liquid Crystal Polyester (LCP) thermoplastic into the mold cavity through the runner defined in the surfaces of the mold cavity retainers and applies between approximately 5.75 pounds per square inch (e.g., between about 525 and 625 pounds per square inch) of pressure to hold the A-side and B-side together for approximately 8 seconds to allow the LCP thermoplastic to set. Sides of the mold press are separated and pressure is applied to the knockout system to force the socket adapter body from the mold thus allowing the manufactured socket adapter mold to fall into a collection bin underneath the mold press. The manufactured socket adapter body has an 25×25 array of apertures with a pitch of approximately 0.5 millimeters.

A number of embodiments of the invention have been described. Nevertheless, it will be understood that various modifications may be made without departing from the spirit and scope of the invention. For example, one alternate embodiment only includes one knockout system. Accordingly, other embodiments are within the scope of the following claims.

What is claimed is:

1. A method of manufacturing a mold for forming an intercoupling component of the type used to couple an array of electrical connection regions disposed on a first substrate to an array of electrical connection regions disposed on a second substrate, the method comprising:
providing a plurality of plates, each plate including an array of holes arranged in a pattern corresponding to the array of electrical connection regions of the first substrate;
forming a base by stacking the plates with the holes substantially aligned;
inserting pins into apertures formed in the base by the aligned holes; and
assembling a housing with the base, pins, at least one sidewall, and a cover, the housing including a substantially enclosed cavity, the housing also including at least one opening to enable injection of molten material into the cavity.

2. The method of claim 1 wherein each plate has a first thickness between about 0.010 inch (0.254 millimeter) and 0.014 inch (0.356 millimeters).

3. The method of claim 2 wherein the base has a second thickness between about 0.20 inch (5.1 millimeters) and 0.70 inch (18 millimeters).

4. The method of claim 2 wherein each plate comprises stainless steel.

5. The method of claim 2 wherein providing the plates comprises forming the array of holes by laser machining each plate.

6. The method of claim 1 wherein forming the base comprises stacking between about 10 and 100 plates.

7. The method of claim 6 wherein forming the base comprises stacking between about 20 and 50 plates.

8. The method of claim 1 wherein providing the plates comprises machining the plates to form the array of holes with a pitch of between about 0.012 inch (0.3 millimeter) and 0.031 inch (0.8 millimeter).

9. The method of claim 1 wherein providing the plates comprises forming the array of holes with diameters between about 0.009 inch (0.229 millimeter) and 0.012 inch (0.305 millimeter).

10. The method of claim 1 wherein assembling the base and pins with the at least one sidewall, and cover comprises contacting an interior surface of the cover with distal ends of the pins.

11. A mold for forming an intercoupling component of the type used to couple an array of electrical connection regions disposed on a first substrate to an array of electrical connection regions disposed on a second substrate, the mold comprising:
a base, at least one sidewall, and a cover, which together define a substantially enclosed cavity, at least one of the base, at least one sidewall, and cover including at least one opening to enable injection of molten material into the cavity; and
pins extending from the base into the mold cavity, the pins having first ends received by the base and second ends contacting an interior surface of the cover,
the base including a plurality of plates, each plate having an array of holes arranged in a pattern corresponding to the array of electrical connection regions of the first substrate.

12. The mold of claim 11 wherein the plurality of plates are stacked with the arrays of holes substantially aligned.

13. The mold of claim 12 wherein the aligned arrays of holes form arrays of apertures receiving the pins.

14. The mold of claim 12 wherein each of the array of holes has a diameter of between about 0.009 inch (0.229 millimeter) and 0.012 inch (0.305 millimeter).

15. The mold of claim 14 wherein the array of holes comprises a first sub-array of holes and a second sub-array of holes.

16. The mold of claim 15 wherein each of the first sub-array of holes has a first diameter and each of the second sub-array of holes has a second diameter that is less than the first diameter.

17. The mold of claim 15 wherein a first subset of core pins is received by the first sub-array of holes and a second subset of core pins is received by the second sub-array of holes, the first subset of core pins having first diameter in the mold cavity that is greater than a second diameter of the second subset of core pins in the mold cavity.

18. The mold of claim 11 wherein each plate has a first thickness between about 0.010 inch (0.254 millimeter) and 0.014 inch (0.356 millimeters).

19. The mold of claim 18 wherein each plate comprises stainless steel.

20. The mold of claim 18 wherein the base has a second thickness between about 0.20 inch (5.1 millimeters) and 0.70 inch (18 millimeters).

21. The mold of claim 11 wherein the array of holes has a pitch of between about 0.012 inch (0.3 millimeter) and 0.031 inch (0.8 millimeter).

22. The mold of claim 11 wherein each core pin comprises a distal end contacting the interior surface of the cover, the distal end having a substantially planar surface such that contact between the distal end and the interior surface of the cover inhibits the flow of molten material between the distal end and the interior surface.
